(19) United States
(12) Patent Application Publication
(10) Pub. No.: US 2022/0144041 A1
(43) Pub. Date: May 12, 2022

(54) VEHICLE, AND AIR OUTLET DEVICE AND AIR OUTLET METHOD FOR AIR-CONDITIONING SYSTEM THEREOF

(71) Applicant: BYD COMPANY LIMITED, Shenzhen (CN)

(72) Inventors: Hua HUANG, Shenzhen (CN); Qun LIANG, Shenzhen (CN); Xianbing CHEN, Shenzhen (CN)

(21) Appl. No.: 17/440,324

(22) PCT Filed: Mar. 12, 2020
(86) PCT No.: PCT/CN2020/079043

§ 371 Date: Sep. 17, 2021

(30) Foreign Application Priority Data
Mar. 20, 2019 (CN) 201910213924.2

(51) Int. Cl. B60H 1/00; B60H 1/34

(52) U.S. Cl. CPC B60H 1/00842; B60H 1/3414; B60H 2001/00092; B60H 2001/3478; B60H 2001/3485; B60H 2001/3471

(57) ABSTRACT

An air outlet device for an air-conditioning system of a vehicle includes an air outlet assembly disposed at air vents of the air-conditioning system and a control unit. The air outlet assembly includes a plurality of first air doors and a plurality of driving components, the plurality of driving components are respectively connected to the plurality of first air doors, and each driving component is configured to drive the corresponding first air door. The control unit is connected to the plurality of driving components, and is configured to control the plurality of driving components to drive the plurality of first air doors to open or close independently.

### CROSS-REFERENCE TO RELATED APPLICATIONS

This application claims priority to Chinese Patent Application No. 201910213924.2 filed by BYD Co., Ltd. on Mar. 20, 2019, and entitled VEHICLE AND AIR OUTLET DEVICE AND AIR OUTLET METHOD FOR AIR CONDITIONING SYSTEM THEREOF.

### FIELD

The present disclosure relates to the field of vehicle technologies, and in particular, to an air outlet device for an air-conditioning system of a vehicle, a vehicle, and an air outlet method for an air-conditioning system of a vehicle.

### BACKGROUND

In the related art, a technology of controlling air outlet states of air vents by rotating an in-vehicle display screen is provided. However, this technology is only applicable to a single display screen. Air vents need to be disposed around an in-vehicle display terminal, and the air outlet effect cannot be achieved in a case that there are a plurality of screens. The in-vehicle display screen has a development trend of large-screen and multi-screen. When air vents of an air outlet assembly are blocked, flow direction transmission of airflow cannot be implemented.

### SUMMARY

The present disclosure is to at least resolve one of the technical problems in the related art to some extent.

Therefore, a first objective of the present disclosure is to provide an air outlet device for an air-conditioning system of a vehicle, to control an airflow direction by controlling opening and closing states of an air outlet assembly, thereby preventing airflow from being blocked, and satisfying the comfort of passengers.

A second objective of the present disclosure is to provide a vehicle.

A third objective of the present disclosure is to provide an air outlet method for an air-conditioning system of a vehicle.

To achieve the foregoing purpose, an embodiment according to a first aspect of the present disclosure provides an air outlet device for an air-conditioning system of a vehicle, including: an air outlet assembly disposed at air vents of the air-conditioning system, the air outlet assembly including a plurality of first air doors and a plurality of driving components, the plurality of driving components being respectively connected to the plurality of first air doors, and each of the driving components being configured to drive the corresponding first air door; and a control unit, the control unit being connected to the plurality of driving components, and being configured to control the plurality of driving components to drive the plurality of first air doors to open or close independently.

According to the air outlet device for an air-conditioning system of a vehicle provided in an embodiment of the present disclosure, the control unit is connected to the plurality of driving components. By controlling the plurality of driving components to drive the plurality of first air doors to open or close independently, the opening and closing states of the air outlet assembly can be controlled, so as to control an airflow direction, thereby preventing airflow from being blocked, and satisfying the comfort of passengers.

In addition, the air outlet device for an air-conditioning system of a vehicle according to the foregoing embodiment of the present disclosure may further include the following additional technical features:

According to an embodiment of the present disclosure, the foregoing air outlet device for an air-conditioning system of a vehicle may further include: a position detection unit, configured to detect positions of a plurality of in-vehicle display terminals of the vehicle. The plurality of in-vehicle display terminals are disposed in front of the air outlet assembly. The control unit is configured to control the plurality of driving components according to the positions of the plurality of in-vehicle display terminals and/or rotation states of the plurality of in-vehicle display terminals.

According to an embodiment of the present disclosure, the control unit is further configured to determine a blocked region and an unblocked region of the air outlet assembly according to the positions of the plurality of in-vehicle display terminals and the rotation states of the plurality of in-vehicle display terminals, and control first air doors among the plurality of first air doors in the blocked region to close and first air doors among the plurality of first air doors in the unblocked region to open.

According to an embodiment of the present disclosure, the control unit is further configured to determine a blocked region and an unblocked region of the air outlet assembly according to the positions of the plurality of in-vehicle display terminals and the rotation states of the plurality of in-vehicle display terminals, control first air doors among the plurality of first air doors in the blocked region and first air doors among the plurality of first air doors in the unblocked region to open, and control the corresponding in-vehicle display terminal in the blocked region to rotate, to change an air outlet direction.

According to an embodiment of the present disclosure, the control unit is further configured to receive a user instruction, and control at least one of the first air doors in the blocked region to open according to the user instruction.

According to an embodiment of the present disclosure, the air-conditioning system includes an air duct, an evaporator, and a warm box. The evaporator is configured to generate cold air. The warm box is configured to generate warm air. The air outlet device further includes: a baffle disposed in the air duct and disposed along a flow direction of air in the air duct, to divide the air duct into a plurality of partitioned air ducts; and a plurality of second air doors disposed between the evaporator and the warm box, the plurality of second air doors being respectively disposed in the plurality of partitioned air ducts, and each of the second air doors being configured to control a flow rate of cold air in the corresponding partitioned air duct. The control unit is configured to control opening degrees of the plurality of second air doors.

According to an embodiment of the present disclosure, in a case that the unblocked region is one of a plurality of unblocked regions of the air outlet assembly, the control unit is further configured to obtain a target air outlet temperature of each of the unblocked regions, and control the opening degree of the second air door in the partitioned air duct corresponding to each of the unblocked regions according to the target air outlet temperature of each of the unblocked regions.

According to an embodiment of the present disclosure, the driving component includes: a gear, the gear being connected to the first air door to drive the first air door to move; a rack, the rack cooperating with the gear to drive the gear to rotate; and a motor, the motor being connected to the rack, and being configured to drive the rack under the control of the control unit.

To achieve the foregoing purpose, an embodiment according to a second aspect of the present disclosure provides a vehicle, including the foregoing air outlet device for an air-conditioning system of a vehicle.

The vehicle according to an embodiment of the present disclosure can control the airflow direction by using the foregoing air outlet device for an air-conditioning system of a vehicle, thereby preventing the airflow from being blocked, and satisfying the comfort of passengers.

To achieve the foregoing purpose, an embodiment according to a third aspect of the present disclosure provides another air outlet method for an air-conditioning system of a vehicle. An air outlet assembly is disposed at air vents of the air-conditioning system. The air outlet assembly includes a plurality of first air doors and a plurality of driving components. The plurality of driving components are respectively connected to the plurality of first air doors. Each driving component is configured to drive the corresponding first air door. The air outlet method includes the following step: controlling the plurality of driving components to drive the plurality of first air doors to open or close independently.

By using the air outlet method for an air-conditioning system of a vehicle according to an embodiment of the present disclosure, the plurality of driving components are controlled to drive the plurality of first air doors to open or close independently, so as to control the airflow direction, thereby preventing the airflow from being blocked, and satisfying the comfort of passengers.

In addition, the air outlet method for an air-conditioning system of a vehicle according to the foregoing embodiment of the present disclosure may further include the following additional technical features:

According to an embodiment of the present disclosure, the controlling the plurality of driving components includes: detecting positions of a plurality of in-vehicle display terminals of the vehicle, the plurality of in-vehicle display terminals being disposed in front of the air outlet assembly; and controlling the plurality of driving components according to the positions of the plurality of in-vehicle display terminals and/or rotation states of the plurality of in-vehicle display terminals.

According to an embodiment of the present disclosure, the controlling the plurality of driving components according to the positions of the plurality of in-vehicle display terminals and/or rotation states of the plurality of in-vehicle display terminals includes: determining a blocked region and an unblocked region of the air outlet assembly according to the positions of the plurality of in-vehicle display terminals and the rotation states of the plurality of in-vehicle display terminals; and controlling first air doors among the plurality of first air doors in the blocked region to close and first air doors among the plurality of first air doors in the unblocked region to open.

According to an embodiment of the present disclosure, the controlling the plurality of driving components according to the positions of the plurality of in-vehicle display terminals and/or rotation states of the plurality of in-vehicle display terminals includes: determining a blocked region and an unblocked region of the air outlet assembly according to the positions of the plurality of in-vehicle display terminals and the rotation states of the plurality of in-vehicle display terminals; and controlling first air doors among the plurality of first air doors in the blocked region and first air doors among the plurality of first air doors in the unblocked region to open, and controlling the corresponding in-vehicle display terminal in the blocked region to rotate, to change an air outlet direction.

According to an embodiment of the present disclosure, the foregoing air outlet method for an air-conditioning system of a vehicle further includes receiving a user instruction, and controlling at least one of the first air doors in the blocked region to open according to the user instruction.

According to an embodiment of the present disclosure, the air-conditioning system includes an air duct, an evaporator, and a warm box. The evaporator is configured to generate cold air. The warm box is configured to generate warm air. A baffle is disposed in the air duct, and is disposed along a flow direction of air in the air duct, to divide the air duct into a plurality of partitioned air ducts. A plurality of second air doors are disposed between the evaporator and the warm box. The plurality of second air doors are respectively disposed in the plurality of partitioned air ducts. Each of the second air doors is configured to control a flow rate of cold air in the corresponding partitioned air duct. The air outlet method further includes controlling opening degrees of the plurality of second air doors.

According to an embodiment of the present disclosure, in a case that the unblocked region is one of a plurality unblocked regions of the air outlet assembly, the controlling opening degrees of the plurality of second air doors includes: obtaining a target air outlet temperature of each of the unblocked regions; and controlling the opening degree of the second air door in the partitioned air duct corresponding to each of the unblocked regions according to the target air outlet temperature of each of the unblocked regions.

The additional aspects and advantages of the present disclosure will be provided in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the description made with reference to the following accompanying drawings.

FIG. 1 is a schematic block diagram of an air outlet device for an air-conditioning system of a vehicle according to some embodiments of the present disclosure;

FIG. 2 is a schematic diagram of an air outlet assembly according to some embodiments of the present disclosure;

FIG. 3 is a schematic block diagram of an air outlet device for an air-conditioning system of a vehicle according to some embodiments of the present disclosure;

FIG. 4 is a schematic diagram of a plurality of in-vehicle display terminals and a guide rail according to some embodiments of the present disclosure;

FIG. 5 is a combined view of a plurality of in-vehicle display terminals and an air outlet assembly according to some embodiments of the present disclosure;

FIG. 6 is a combined view of a plurality of in-vehicle display terminals and an air outlet assembly according to some embodiments of the present disclosure;

FIG. 7 is a combined view of a plurality of in-vehicle display terminals and an air outlet assembly according to some embodiments of the present disclosure;

FIG. 8 is a schematic diagram of rotation of an in-vehicle display terminal according to some embodiments of the present disclosure;

FIG. 9 is a schematic principle diagram of a regional temperature difference of an air-conditioning system according to some embodiments of the present disclosure;

FIG. 10 is a schematic block diagram of a vehicle according to an embodiment of the present disclosure; and

FIG. 11 is a flowchart of an air outlet method for an air-conditioning system of a vehicle according to an embodiment of the present disclosure.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are exemplary, and are intended to explain the present disclosure and cannot be construed as a limitation to the present disclosure.

A method and an apparatus of the embodiments of the present disclosure are described below with reference to the accompanying drawings.

FIG. 1 is a schematic block diagram of an air outlet device for an air-conditioning system of a vehicle according to some embodiments of the present disclosure.

As shown in FIG. 1, the air outlet device for an air-conditioning system of a vehicle according to some embodiments of the present disclosure may include: an air outlet assembly 10 disposed at air vents of the air-conditioning system and a control unit 20.

The air outlet assembly 10 includes a plurality of first air doors 11 and a plurality of driving components 12. The plurality of driving components 12 are respectively connected to the plurality of first air doors 11. Each driving component 12 is configured to drive the corresponding first air door 11. The control unit 20 is connected to the plurality of driving components 12. The control unit 20 is configured to control the plurality of driving components 12 to drive the plurality of first air doors 11 to open or close independently.

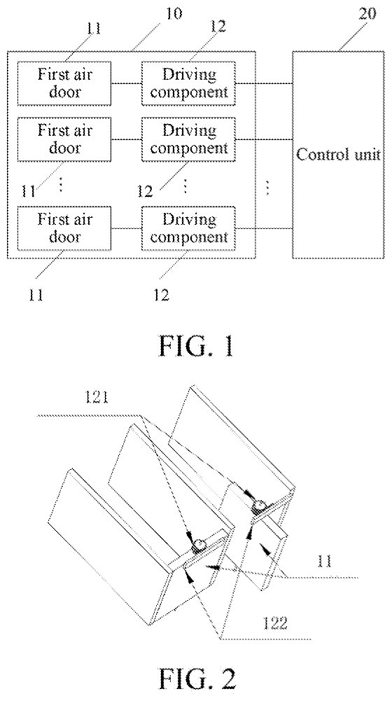

According to an embodiment of the present disclosure, as shown in FIG. 2, each driving component 12 may include: a gear 121, a rack 122, and a motor (not specifically shown in the figure). The gear 121 is connected to the corresponding first air door 11, to drive the first air door 11 to move. The rack 122 cooperates with the gear 121 to drive the gear 121 to rotate. The motor is connected to the rack 122, and is configured to drive the rack 122 under the control of the control unit 20. The air outlet assembly 10 is installed behind in-vehicle display terminals, such as being installed on a dashboard. The air outlet assembly 10 may have a structure extending left and right, and may be adaptively extended and contracted according to a quantity of the in-vehicle display terminals.

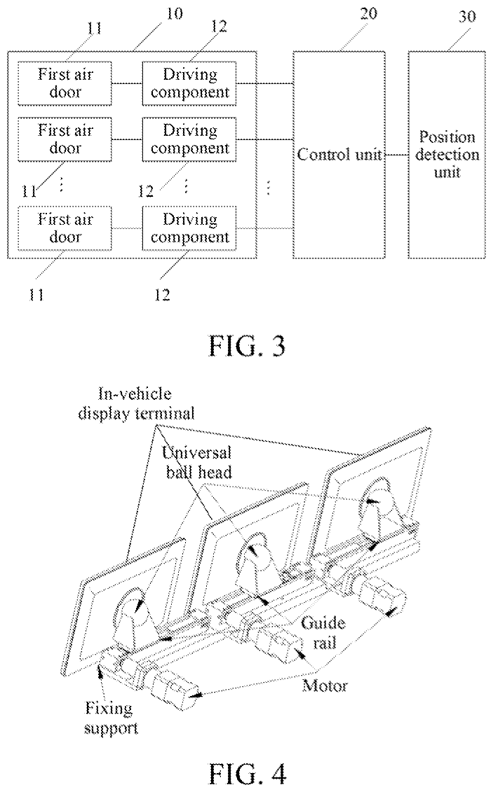

Therefore, by using the air outlet device for the present disclosure, the plurality of first air doors are controlled to open or close independently, thereby saving energy while ensuring that the air vents are not blocked. According to some embodiments of the present disclosure, as shown in FIG. 3, the foregoing air outlet device for an air-conditioning system of a vehicle may further include: a position detection unit 30, configured to detect positions of a plurality of in-vehicle display terminals of the vehicle. The plurality of in-vehicle display terminals are disposed in front of the air outlet assembly 10. The control unit 20 controls the plurality of driving components 12 according to the positions of the plurality of in-vehicle display terminals and/or rotation states of the plurality of in-vehicle display terminals.

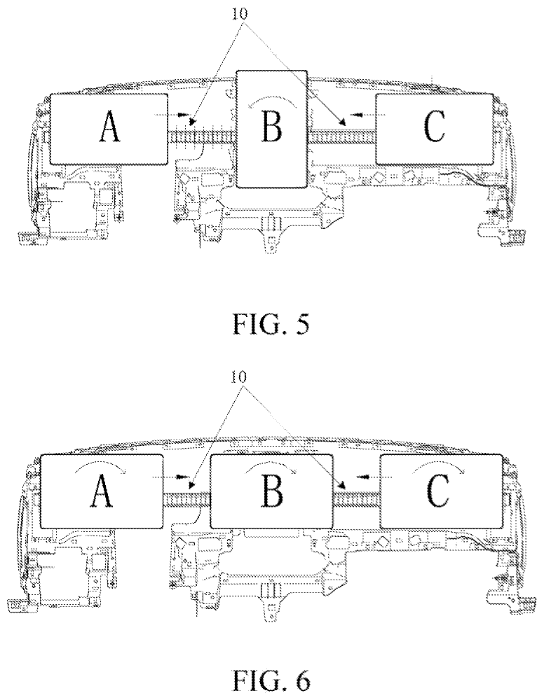

In other words, according to the positions of the plurality of in-vehicle display terminals, the plurality of driving components 12 drive the plurality of first air doors 11 to open or close independently. For example, as shown in FIG. 5, according to a position of an in-vehicle display terminal A, a plurality of driving components drive a plurality of first air doors in a region blocked by the in-vehicle display terminal to close. According to the rotation states of the plurality of in-vehicle display terminals, the plurality of driving components 12 drive the plurality of first air doors to open or close independently. For example, as shown in FIG. 5, rotation states of the in-vehicle display terminal A, an in-vehicle display terminal B, and an in-vehicle display terminal C are different, and quantities of first air doors that are blocked by the in-vehicle display terminals A, B. and C are also different. In this case, the control unit 20 controls a plurality of driving components in regions blocked by the in-vehicle display terminals A, B, and C to drive a plurality of corresponding first air doors to close, and controls a plurality of driving components outside the regions blocked by the in-vehicle display terminals A, B, and C to drive a plurality of corresponding first air doors to open, thereby achieving the air outlet effect and saving energy. The plurality of driving components may be further controlled according to the positions of the plurality of in-vehicle display terminals and the rotation states of plurality of in-vehicle display terminals, to realize more precise control.

According to an embodiment of the present disclosure, the control unit 20 is further configured to determine a blocked region and an unblocked region of the air outlet assembly 10 according to the positions of the plurality of in-vehicle display terminals and the rotation states of the plurality of in-vehicle display terminals, and control first air doors 11 in the blocked region to close and first air doors 11 in the unblocked region to open. The blocked region is an air outlet region of the air outlet assembly that is blocked by the in-vehicle display terminal, that is, a region from which the air outlet assembly cannot let out air. The unblocked region is an air outlet region of the air outlet assembly that is not blocked by the in-vehicle display terminal, that is, a region from which the air outlet assembly can normally let out air.

In other words, all the first air doors 11 in the blocked region are controlled to be closed, which can save energy; and all the first air doors in the unblocked region are controlled to be open, which can satisfy a requirement for temperature adjustment of a driver. In addition, in a case that the driver has a heating requirement, closing all the first air doors 11 in the blocked region can effectively avoid the continuous temperature rise in the blocked region, and equipment aging or safety hazards due to the temperature rise for a long time.

It should be noted that, in a case that a part of a certain first air door in the plurality of first air doors is blocked by an in-vehicle display terminal, an air outlet region where the certain first air door is located also belongs to the blocked region. In this case, the first air door is controlled to be closed.

Specifically, as shown in FIG. 4, the in-vehicle display terminals are connected to universal ball heads for rotation, so as to change display directions of the in-vehicle display terminals. In addition, the in-vehicle display terminals slide left and right on a guide rail driven by drive motors of the in-vehicle display terminals, to change the positions of the in-vehicle display terminals. In this way, the in-vehicle display terminals may be spliced together to form a large display screen, or may be combined into different forms. For example, as shown in FIG. 5 and FIG. 6, A, B, and C represent the in-vehicle display terminals, and arrow directions represent movement directions and rotation directions of the in-vehicle display terminals. It is assumed that sizes of the in-vehicle display terminals A, B, and C are all 20 cm*15 cm (length*width), a large display screen of 60 cm*15 cm may be obtained by splicing as shown in FIG. 5, and a large display screen of 45 cm*20 cm may be obtained by splicing as shown in FIG. 6.

It may be understood that, FIG. 4 to FIG. 6 merely illustrate some embodiments of the present disclosure. The present disclosure includes but is not limited to three in-vehicle display terminals, and may alternatively include two or four in-vehicle display terminals, or the like.

A laser sensor is disposed in the air outlet assembly 10. The laser sensor is configured to detect position information of the in-vehicle display terminals according to a distance setting, and transmit the position information to the control unit 20 through a controller area network (CAN) signal. The control unit 20 (for example, the control unit 20 may be a micro controller unit (MCU)) drives, according to received position information, the motors to control the first air doors 11 to open or close. For example, in a case that the position of the in-vehicle display terminal A blocks the corresponding first air doors 11, the control unit 20 controls the air doors corresponding to the position to close and the first air doors 11 corresponding to the unblocked regions to open.

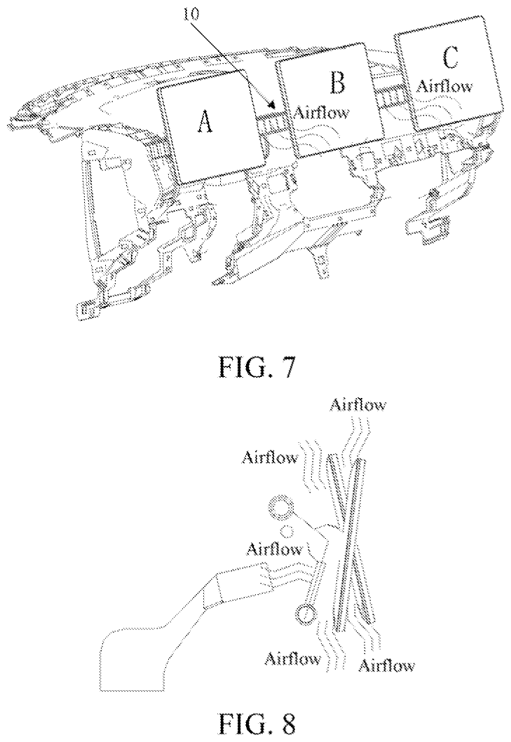

In other words, as shown in FIG. 7, as a position of an in-vehicle display terminal moves, the position detection unit 30 (for example, the laser sensor) acquires the position of the in-vehicle display terminal. According to the position of the in-vehicle display terminal, the control unit 20 controls the opening and closing states of the air vents at different positions. The quantities of the air vents that are blocked are different when the in-vehicle display terminal is in a landscape state and a portrait state. In a case that the position detection unit 30 acquires a position change, the quantities of the opening and closing states of the plurality of first air doors may also change correspondingly. Therefore, the air doors that are blocked by the positions of the in-vehicle display terminals can be closed, and the air doors in the regions that are not blocked by the in-vehicle display terminals can be opened, so as to prevent airflow from being blocked by the in-vehicle display terminals. In this way, air can flow out from the unblocked regions, to maximize the energy of the airflow, thereby realizing energy conservation and environmental protection.

According to some embodiments of the present disclosure, the control unit 20 is further configured to determine a blocked region and an unblocked region of the air outlet assembly 10 according to the positions of the plurality of in-vehicle display terminals and the rotation states of the plurality of in-vehicle display terminals, control all first air doors 11 in the blocked region and the unblocked region to open, and control the corresponding in-vehicle display terminal in the blocked region to rotate, so as to change an air outlet direction.

According to some embodiments of the present disclosure, the control unit 20 is further configured to receive a user instruction, and control at least one of the first air doors 11 in the blocked region to open according to the user instruction.

Specifically, as shown in FIG. 8, in a case that an in-vehicle display terminal blocks first air doors, in order to dissipate heat from the in-vehicle display terminal, a temperature sensor (not shown in the figure) may be disposed on the in-vehicle display terminal to detect a temperature of the in-vehicle display terminal, and feed back a high-temperature region of the in-vehicle display terminal to the control unit 20. The control unit 20 may further control at least one of first air doors 11 corresponding to the high-temperature region of the in-vehicle display terminal in the blocked region to open, so as to dissipate heat from the in-vehicle display terminal; and control the universal ball head to rotate the in-vehicle display terminal, so as to change the air outlet direction of the first air door 11, thereby blowing air into the vehicle while dissipating heat from the in-vehicle display terminal. Blowing cold air can dissipate heat from the plurality of in-vehicle display terminals.

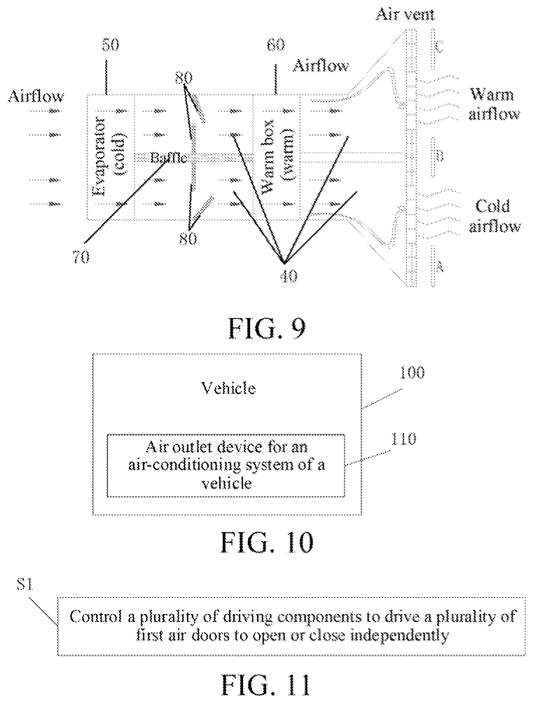

According to some embodiments of the present disclosure, as shown in FIG. 9, the air-conditioning system may include an air duct 40, an evaporator 50, and a warm box 60. The evaporator 50 is configured to generate cold air. The warm box 60 is configured to generate warm air. The air outlet device 110 may further include: a baffle 70 disposed in the air duct 40, the baffle 70 being disposed along a flow direction of air in the air duct 40, to separate the air duct 40 into a plurality of partitioned air ducts (the plurality of partitioned air duct divide the air duct into a plurality of regions); and a plurality of second air doors 80 disposed between the evaporator and the warm box, the plurality of second air doors 80 being correspondingly disposed in the plurality of partitioned air ducts respectively, and each second air door being configured to control a flow rate of cold air in the corresponding partitioned air duct. The control unit 20 is configured to control opening degrees of the plurality of second air doors. Each partitioned air duct corresponds to first air doors in a certain region. For example, as shown in FIG. 9, the partitioned air duct in the upper part of the figure corresponds to controlling a plurality of first air doors in the unblocked region to open, to blow out warm airflow; and the partitioned air duct in the lower part of the figure corresponds to controlling a plurality of first air doors in the unblocked region to open, to blow out cold airflow. It may be understood that, the upper part shown in FIG. 9 may also blow out cold airflow, and the lower part may also blow out warm airflow, which may be defined according to actual requirements.

It should be noted that, the second air doors are rotatable or movable.

According to some embodiments of the present disclosure, in a case that there are plural unblocked regions of the air outlet assembly, the control unit 20 is further configured to obtain a target air outlet temperature of each unblocked region, and control the opening degree of the second air door in the partitioned air duct corresponding to each unblocked region according to the target air outlet temperature of each unblocked region.

Specifically, as shown in FIG. 9, the present disclosure can further implement different air outlet temperatures in different air outlet regions. The airflow enters the partitioned air ducts through the isolated evaporator and the warm box with the baffle, and then flows out of the air outlet assembly. The second air doors (air vent open-and-close units) are disposed between the evaporator and the warm box. An opening and closing amount of each second air door is controlled to implement cooling and heating control. For example, in a case that the target outlet temperature between the in-vehicle display terminals B and C is detected to be high, the control unit 20 may increase an opening degree of a corresponding second air door to increase a flow rate of cold airflow flowing through, so as to increase a flow rate of cold airflow entering the warm box and reduce a temperature of warm airflow flowing out of the warm box, thereby reducing the target air outlet temperature. In a case that the target outlet temperature between the in-vehicle display terminals A and B is detected to be high, the control unit 20 may increase an opening degree of a corresponding second air door to increase a flow rate of cold airflow flowing through, so as to increase a flow rate of cold airflow entering the warm box and reduce a temperature of warm airflow flowing out of the warm box, thereby reducing the target air outlet temperature. In this way, different air vents blow out airflow with different temperatures. Specifically, in a case that a temperature of a region facing the in-vehicle display terminal is 20° C. while a required temperature of a driver is 23° C., the opening degree of the second air door may be adjusted to satisfy the requirement of the driver.

In conclusion, the air outlet device for an air-conditioning system of a vehicle provided in the present disclosure is the interaction of the plurality of in-vehicle display terminals. The opening and closing states of the air outlet assembly can be controlled through movement of the in-vehicle display terminals, to control the airflow direction, thereby preventing the airflow from being blocked. The airflow is controlled to dissipate heat from the in-vehicle display terminals. The direction of the airflow is guided through the in-vehicle display terminals, to satisfy the comfort of passengers.

Based on the above, according to the air outlet device for an air-conditioning system of a vehicle provided in some embodiments of the present disclosure, the control unit is connected to the plurality of driving components. By controlling the plurality of driving components to drive the plurality of first air doors to open or close independently, the opening and closing states of the air outlet assembly can be controlled, so as to control an airflow direction, thereby preventing airflow from being blocked, and satisfying the comfort of passengers.

FIG. 10 is a schematic block diagram of a vehicle according to an embodiment of the present disclosure.

As shown in FIG. 10, the vehicle 100 according to an embodiment of the present disclosure may include: the foregoing air outlet device 110 of an air-conditioning system of a vehicle.

The vehicle according to an embodiment of the present disclosure can control the airflow direction by using the foregoing air outlet device for an air-conditioning system of a vehicle, thereby preventing the airflow from being blocked, and satisfying the comfort of passengers.

According to the foregoing embodiments, the present disclosure further provides an air outlet method for an air-conditioning system of a vehicle.

In an embodiment of the present disclosure, an air outlet assembly is disposed at air vents of the air-conditioning system. The air outlet assembly includes a plurality of first air doors and a plurality of driving components. The plurality of driving components are respectively connected to the plurality of first air doors. Each driving component is configured to drive the corresponding first air door.

FIG. 11 is a flowchart of an air outlet method for an air-conditioning system of a vehicle according to an embodiment of the present disclosure.

As shown in FIG. 11, the air outlet method for an air-conditioning system of a vehicle according to an embodiment of the present disclosure may include the following step: SI. Control a plurality of driving components to drive a plurality of first air doors to open or close independently.

According to an embodiment of the present disclosure, the controlling the plurality of driving components includes: detecting positions of a plurality of in-vehicle display terminals of the vehicle, the plurality of in-vehicle display terminals being disposed in front of the air outlet assembly; and controlling the plurality of driving components according to the positions of the plurality of in-vehicle display terminals and rotation states of the plurality of in-vehicle display terminals.

According to an embodiment of the present disclosure, the controlling the plurality of driving components according to the positions of the plurality of in-vehicle display terminals and/or rotation states of the plurality of in-vehicle display terminals includes: determining a blocked region and an unblocked region of the air outlet assembly according to the positions of the plurality of in-vehicle display terminals and the rotation states of the plurality of in-vehicle display terminals; and controlling first air doors among the plurality of first air doors in the blocked region to close and first air doors among the plurality of first air doors in the unblocked region to open.

According to an embodiment of the present disclosure, the controlling the plurality of driving components according to the positions of the plurality of in-vehicle display terminals and/or rotation states of the plurality of in-vehicle display terminals includes: determining a blocked region and an unblocked region of the air outlet assembly according to the positions of the plurality of in-vehicle display terminals and the rotation states of the plurality of in-vehicle display terminals; and controlling first air doors among the plurality of first air doors in the blocked region and first air doors among the plurality of first air doors in the unblocked region to open, and controlling the corresponding in-vehicle display terminal in the blocked region to rotate, to change an air outlet direction.

According to an embodiment of the present disclosure, the foregoing air outlet method for an air-conditioning system of a vehicle further includes: receiving a user instruction, and controlling at least one of the first air doors in the blocked region to open according to the user instruction.

According to an embodiment of the present disclosure, the air outlet method for an air-conditioning system of a vehicle further includes controlling, in a case that at least one of the first air doors in the blocked region is opened, the corresponding in-vehicle display terminal in the blocked region to rotate, to change an air outlet direction.

According to an embodiment of the present disclosure, the air-conditioning system includes an air duct, an evaporator, and a warm box. The evaporator is configured to generate cold air. The warm box is configured to generate warm air. A baffle is disposed in the air duct, and is disposed along a flow direction of air in the air duct, to divide the air duct into a plurality of partitioned air ducts. A plurality of second air doors are disposed between the evaporator and the warm box. The plurality of second air doors are respectively disposed in the plurality of partitioned air ducts. Each of the second air doors is configured to control a flow rate of cold air in the corresponding partitioned air duct. The air outlet method further includes controlling opening degrees of the plurality of second air doors.

According to an embodiment of the present disclosure, in a case that the unblocked region is one of a plurality unblocked regions of the air outlet assembly, the controlling opening degrees of the plurality of second air doors includes: obtaining a target air outlet temperature of each of the unblocked regions, and controlling the opening degree of the second air door in the partitioned air duct corresponding to each of the unblocked regions according to the target air outlet temperature of each of the unblocked regions.

It should be noted that reference is made to the details disclosed in the air outlet device for an air-conditioning system of a vehicle according to the embodiments of the present disclosure for details that are not disclosed in the air outlet method for an air-conditioning system of a vehicle according to the embodiments of the present disclosure, and no repeated description is provided herein.

By using the air outlet method for an air-conditioning system of a vehicle according to an embodiment of the present disclosure, the plurality of driving components are controlled to drive the plurality of first air doors to open or close independently, so as to control the airflow direction, thereby preventing the airflow from being blocked, and satisfying the comfort of passengers.

In the description of this specification, the description of the reference terms such as “an embodiment”, “some embodiments”, “example”, “specific example”, or “some examples” means that the specific features, structures, materials or characteristics described with reference to the embodiment or example are included in at least one embodiment or example of the present disclosure. In the present specification, schematic representations of the above terms are not necessarily directed to the same embodiments or examples. Moreover, the specific features, structures, materials, or characteristics described may be combined in any one or more embodiments or examples in a suitable manner. In addition, different embodiments or examples described in the present specification, as well as features of different embodiments or examples, may be integrated and combined by those skilled in the art without contradicting each other.

In addition, terms “first” and “second” are used merely for the purpose of description, and shall not be construed as indicating or implying relative importance or implying a quantity of indicated technical features. Therefore, features defining “first” and “second” can explicitly or implicitly include at least one of the features. In the descriptions of the present disclosure, unless explicitly specified, “multiple” means at least two, for example, two or three.

Any process or method description in the flowchart or described in other ways herein can be understood as a module, segment or part of a code that includes one or more executable instructions for implementing customized logic functions or steps of the process, and the scopes of the preferred embodiments of the present disclosure include additional implementations, which may not be in the order shown or discussed, including performing functions in a substantially simultaneous manner or in reverse order according to the functions involved. This should be understood by a person skilled in the art to which the embodiments of the present disclosure belong.

The logic and/or steps shown in the flowcharts or described in any other manner herein, for example, a sequenced list that may be considered as executable instructions used for implementing logical functions, may be specifically implemented in any computer readable medium to be used by an instruction execution system, apparatus, or device (for example, a computer-based system, a system including a processor, or another system that can obtain an instruction from the instruction execution system, apparatus, or device and execute the instruction) or to be used by combining such instruction execution systems, apparatuses, or devices. In the context of the present disclosure, a “computer-readable medium” may be any apparatus that can include, store, communicate, propagate, or transmit the program for use by the instruction execution system, apparatus, or device or in combination with the instruction execution system, apparatus, or device. More specific examples (a non-exhaustive list) of the computer-readable medium include the following: an electrical connection (electronic device) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the computer-readable medium can even be paper or other suitable media on which the program can be printed, because the program can be obtained electronically by, for example, optically scanning paper or other media, then editing, interpreting, or processing in other suitable ways if necessary, and then storing it in a computer memory.

It should be understood that, parts of the present disclosure can be implemented by using hardware, software, firmware, or a combination thereof. In the foregoing implementations, a plurality of steps or methods may be implemented by using software or firmware that are stored in a memory and are executed by a proper instruction execution system. For example, if hardware is used for implementation, same as in another implementation, implementation may be performed by any one of the following technologies well known in the art or a combination thereof: a discrete logic circuit of a logic gate circuit for realizing a logic function for a data signal, an application-specific integrated circuit having a suitable combined logic gate circuit, a programmable gate array (PGA), and a field programmable gate array (FPGA).

A person of ordinary skill in the art may understand that all or some of the steps of the methods in the foregoing embodiments may be implemented by a program instructing relevant hardware. The program may be stored in a computer-readable storage medium. When the program is executed, one or a combination of the steps of the method embodiments are performed.

In addition, the functional modules in the embodiments of the present disclosure may be integrated into one processing module, or each of the units may exist alone physically, or two or more units may be integrated into one module. The integrated module may be implemented in the form of hardware, or may be implemented in a form of a software functional module. If implemented in the form of software functional modules and sold or used as an independent product, the integrated module may also be stored in a computer-readable storage medium.

The storage medium mentioned above may be a read-only memory, a magnetic disk, an optical disc, or the like. Although the embodiments of the present disclosure have been shown and described above, it can be understood that, the foregoing embodiments are exemplary and should not be understood as limitation to the present disclosure. A person of ordinary skill in the art can make changes, modifications, replacements, or variations to the foregoing embodiments within the scope of the disclosure.

1. An air outlet device for an air-conditioning system of a vehicle, comprising:
an air outlet assembly disposed at air vents of the air-conditioning system, the air outlet assembly comprising a plurality of first air doors and a plurality of driving components, the plurality of driving components being respectively connected to the plurality of first air doors, and each of the driving components being configured to drive the corresponding first air door; and
a control unit, the control unit being connected to the plurality of driving components, and being configured to control the plurality of driving components to drive the plurality of first air doors to open or close independently.

2. The air outlet device for an air-conditioning system of a vehicle according to claim 1, further comprising:
a position detection unit, the position detection unit being configured to detect positions of a plurality of in-vehicle display terminals of the vehicle, the plurality of in-vehicle display terminals being disposed in front of the air outlet assembly,
wherein the control unit is configured to control the plurality of driving components according to the positions of the plurality of in-vehicle display terminals and rotation states of the plurality of in-vehicle display terminals; or, the control unit is configured to control the plurality of driving components according to the positions of the plurality of in-vehicle display terminals; or, the control unit is configured to control the plurality of driving components according to rotation states of the plurality of in-vehicle display terminals.

3. The air outlet device for an air-conditioning system of a vehicle according to claim 2, wherein the control unit is further configured to determine a blocked region and an unblocked region of the air outlet assembly according to the positions of the plurality of in-vehicle display terminals and the rotation states of the plurality of in-vehicle display terminals, and control first air doors among the plurality of first air doors in the blocked region to close and first air doors among the plurality of first air doors in the unblocked region to open.

4. The air outlet device for an air-conditioning system of a vehicle according to claim 2, wherein the control unit is further configured to determine a blocked region and an unblocked region of the air outlet assembly according to the positions of the plurality of in-vehicle display terminals and the rotation states of the plurality of in-vehicle display terminals, control first air doors among the plurality of first air doors in the blocked region and first air doors among the plurality of first air doors in the unblocked region to open, and control a corresponding in-vehicle display terminal among the plurality of in-vehicle display terminals in the blocked region to rotate, to change an air outlet direction.

5. The air outlet device for an air-conditioning system of a vehicle according to claim 3, wherein the control unit is further configured to receive a user instruction, and control at least one of the first air doors in the blocked region to open according to the user instruction.

6. The air outlet device for an air-conditioning system of a vehicle according to claim 3, wherein the air-conditioning system comprises an air duct, an evaporator, and a warm box, the evaporator is configured to generate cold air, and the warm box is configured to generate warm air; and the air outlet device further comprises:
a baffle disposed in the air duct, the baffle being disposed along a flow direction of air in the air duct, to divide the air duct into a plurality of partitioned air ducts; and
a plurality of second air doors disposed between the evaporator and the warm box, the plurality of second air doors being respectively disposed in the plurality of partitioned air ducts, and each of the second air doors being configured to control a flow rate of cold air in the corresponding partitioned air duct, wherein the control unit is configured to control opening degrees of the plurality of second air doors.

7. The air outlet device for an air-conditioning system of a vehicle according to claim 6, wherein when the unblocked region is one of a plurality of unblocked regions of the air outlet assembly, the control unit is further configured to obtain a target air outlet temperature of each of the unblocked regions, and control the opening degree of the second air door in the partitioned air duct corresponding to each of the unblocked regions according to the target air outlet temperature of each of the unblocked regions.

8. The air outlet device for an air-conditioning system of a vehicle according to claim 1, wherein the driving component comprises:
a gear, the gear being connected to the first air door to drive the first air door to move;
a rack, the rack cooperating with the gear to drive the gear to rotate; and
a motor, the motor being connected to the rack, and being configured to drive the rack under the control of the control unit.

9. A vehicle, comprising an air outlet device for an air-conditioning system of a vehicle, the air outlet device comprising:
an air outlet assembly disposed at air vents of the air-conditioning system, the air outlet assembly comprising a plurality of first air doors and a plurality of driving components, the plurality of driving components being respectively connected to the plurality of first air doors, and each of the driving components being configured to drive the corresponding first air door; and
a control unit, the control unit being connected to the plurality of driving components, and being configured to control the plurality of driving components to drive the plurality of first air doors to open or close independently.

10. An air outlet method for an air-conditioning system of a vehicle, wherein an air outlet assembly is disposed at air vents of the air-conditioning system, the air outlet assembly comprises a plurality of first air doors and a plurality of driving components, the plurality of driving components are respectively connected to the plurality of first air doors, and each of the driving components is configured to drive the corresponding first air door, the air outlet method comprising:
controlling the plurality of driving components to drive the plurality of first air doors to open or close independently.

11. The air outlet method for an air-conditioning system of a vehicle according to claim 10, wherein the controlling the plurality of driving components comprises:
detecting positions of a plurality of in-vehicle display terminals of the vehicle, the plurality of in-vehicle display terminals being disposed in front of the air outlet assembly; and
controlling the plurality of driving components according to the positions of the plurality of in-vehicle display terminals and rotation states of the plurality of in-vehicle display terminals.

12. The air outlet method for an air-conditioning system of a vehicle according to claim 11, wherein the controlling the plurality of driving components according to the positions of the plurality of in-vehicle display terminals and rotation states of the plurality of in-vehicle display terminals comprises:
determining a blocked region and an unblocked region of the air outlet assembly according to the positions of the plurality of in-vehicle display terminals and the rotation states of the plurality of in-vehicle display terminals; and
controlling first air doors among the plurality of first air doors in the blocked region to close and first air doors among the plurality of first air doors in the unblocked region to open.

13. The air outlet method for an air-conditioning system of a vehicle according to claim 11, wherein the controlling the plurality of driving components according to the positions of the plurality of in-vehicle display terminals and rotation states of the plurality of in-vehicle display terminals comprises:
determining a blocked region and an unblocked region of the air outlet assembly according to the positions of the plurality of in-vehicle display terminals and the rotation states of the plurality of in-vehicle display terminals; and
controlling first air doors among the plurality of first air doors in the blocked region and first air doors among the plurality of first air doors in the unblocked region to open, and controlling a corresponding in-vehicle display terminal among the plurality of in-vehicle display terminals in the blocked region to rotate, to change an air outlet direction.

14. The air outlet method for an air-conditioning system of a vehicle according to claim 12, further comprising:
receiving a user instruction, and controlling at least one of the first air doors in the blocked region to open according to the user instruction.

15. The air outlet method for an air-conditioning system of a vehicle according to claim 12, wherein:
the air-conditioning system comprises an air duct, an evaporator, and a warm box, the evaporator is configured to generate cold air, and the warm box is configured to generate warm air;
a baffle is disposed in the air duct, and is disposed along a flow direction of air in the air duct, to divide the air duct into a plurality of partitioned air ducts;
a plurality of second air doors are disposed between the evaporator and the warm box, the plurality of second air doors are respectively disposed in the plurality of partitioned air ducts, and each of the second air doors is configured to control a flow rate of cold air in the corresponding partitioned air duct; and
the air outlet method further comprises:
controlling opening degrees of the plurality of second air doors.

16. The air outlet method for an air-conditioning system of a vehicle according to claim 15, wherein when the unblocked region is one of a plurality unblocked regions of the air outlet assembly, the controlling opening degrees of the plurality of second air doors comprises:
obtaining a target air outlet temperature of each of the unblocked regions; and
controlling the opening degree of the second air door in the partitioned air duct corresponding to each of the unblocked regions according to the target air outlet temperature of each of the unblocked regions.
